(19) United States
(12) Patent Application Publication
(10) Pub. No.: US 2010/0019082 A1
(43) Pub. Date: Jan. 28, 2010

(54) Composite Flight Control Cables

(75) Inventors: Curtiss Drew Carter, Mojave, CA (US); Charles Thomas Coleman, Mojave, CA (US); Robert Joseph Morgan, Mojave, CA (US)

Correspondence Address: FRIED, FRANK, HARRIS, SHRIVER & JACOBSON LLP, ONE NEW YORK PLAZA, NEW YORK, NY, 10004, US

(73) Assignee: TSC, LLC, New York, NY (US)

(21) Appl. No.: 12/508,454

(22) Filed: Jul. 23, 2009

Related U.S. Application Data
(60) Provisional application No. 61/083,795, filed on Jul. 25, 2008.

(51) Int. Cl. B64C 13/30; D07B 5/00; F16C 1/20

(52) U.S. Cl. 244/99.3; 427/177; 74/502.5

(57) ABSTRACT

A flight control system includes carbon fiber pull rods to substitute in whole or in part for conventional steel cables. The stretch and thermal expansion issues associated with composite cables are minimal, making them much better for the very long flight-control runs on large aircraft and spacecraft, and also on aircraft and spacecraft operating though a wide range of temperatures during flight. In a preferred embodiment, the carbon fiber pull rods are manufactured by winding a resin-impregnated carbon tow around a pair of bobbins, one of which is fixed and one of which is rotatably mounted. When the second bobbin is rotated, the windings are twisted to form the carbon fiber pull rod, which is then cured to complete the manufacturing process.

This application claims priority to U.S. Provisional Patent Application Ser. No. 61/083,795, entitled “Composite Flight Control Cables,” filed Jul. 25, 2008, which is hereby incorporated by reference in its entirety for each of its embodiments and teachings.

### BACKGROUND OF THE INVENTION

Steel cables have traditionally been used in aircraft control systems to connect the cockpit to control surfaces of the aircraft. But issues arise when using traditional steel cables for long flight-control runs on large aircraft and spacecraft, particularly where those large aircraft and spacecraft must operate through a range of temperatures during flight. Steel cables have a tendency to stretch, which can reduce effectiveness of the control system. Moreover, the properties of steel change significantly with temperature due to its Coefficient of Thermal Expansion (CTE).

For example, in aircraft with cable runs that approach or exceed 1400 inches, a 5/32 inch diameter steel cable subjected to a Federal Aviation Regulation (“FAR”) allowable maximum pilot effort load would exhibit 12.1 inches of cable stretch over the 1400 inch run. Moreover, steel cable preloaded to 150 pounds tension would contract by 2.6 inches over a 1400 inch run due to temperature changes between sea level and a design service ceiling. That thermal contraction increases the steel cable load from 150 pounds to 500 pounds.

### SUMMARY OF THE INVENTION

Improved flight control cables are disclosed that do not exhibit the above problems of cable stretch and thermal expansion. In a preferred embodiment, the flight control cables comprise one or more carbon fiber pull rods. The carbon fiber pull rods are manufactured by winding a resin-impregnated carbon tow around a pair of bobbins, one of which is fixed and one of which is rotatably mounted. When the second bobbin is rotated, the windings are twisted to form the carbon fiber pull rod, which is then cured to complete the manufacturing process.

The finished carbon fiber pull rods may be used to substitute in whole or in part for conventional steel cables in the flight control system. Where a control cable in the flight control system passes around a pulley or sector, that portion of the cable that passes around the pulley or sector is preferably constructed of conventional stainless steel and a transition or interface between the steel portions of the cable and the carbon fiber portions of the cable is made.

The carbon fiber pull rods of the present invention provide excellent stretch and thermal expansion properties making them much better for very long flight control runs on large aircraft and spacecraft, and also on aircraft and spacecraft operating though a wide range of temperatures during flight. In addition, the thermal expansion properties of the carbon fiber pull rods of the present invention will typically be more similar to those of other composite components of the aircraft, which may include all or part of the fuselage, wings, or tail structure. Thus, the carbon fiber pull rods of the present invention and these other aircraft components will expand and contract in a similar fashion in response to temperature changes.

The present disclosure describes the use of control cables and carbon fiber pull rods primarily in connection with aircraft control systems intended to be compliant with FAR Parts 23 and 25 pertaining to airplane airworthiness standards. The cables and carbon fiber pull rods of the present invention may also find use in other applications, particularly in applications where long cables are required such as control systems on yachts and other large boats.

### BRIEF DESCRIPTION OF THE DRAWINGS

These and other features, benefits, and advantages of the present disclosure will become apparent from the following detailed description, which refers to the accompanying drawings, wherein like reference numerals refer to like features across the several views, and wherein:

FIG. 1 illustrates an aircraft in which use of the cables of the present invention is contemplated;

FIG. 2 illustrates a preferred embodiment of a carbon fiber pull rod of the present invention;

FIG. 3 is a flow chart illustrating a preferred embodiment for manufacturing carbon fiber pull rods in accordance with the principles of the present invention;

FIG. 4 illustrates the bonding surfaces of a bobbin that may be used in constructing a carbon fiber pull rod of the present invention;

FIGS. 5-12 illustrate aspects of the process for manufacturing carbon fiber pull rods in accordance with the principles of the present invention; and

FIG. 13 illustrates a carbon fiber pull rod connected to a steel cable in accordance with the principles of the present invention.

### DETAILED DESCRIPTION OF THE PREFERRED EMBODIMENTS

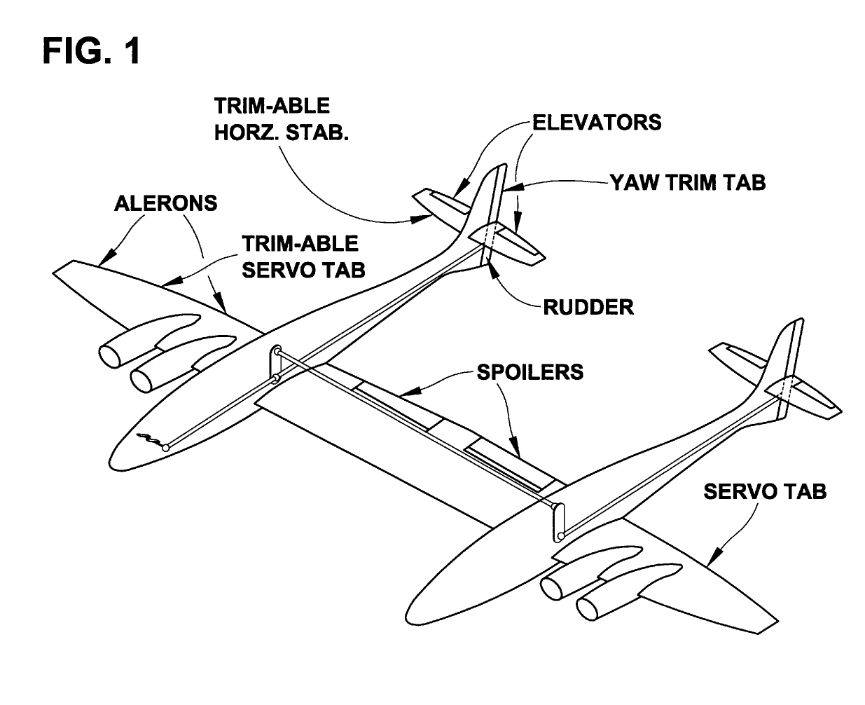

Referring now to FIG. 1, an aircraft titled White Knight 2 is illustrated. The White Knight 2 is a twin-fuselage, twin-empennage design, currently contemplated to have a wingspan of approximately 140 feet, and the length of approximately 80 feet. The distances involved in the control system of this aircraft are significant, particularly the link between the control surfaces of the port empennage and the cockpit located in the starboard fuselage, and there is a need to ensure that the control surfaces of both empennage work in coordination with each other. FIG. 1 illustrates the longest of cable runs in the control system, stretching from the cockpit in the fore section of the starboard fuselage to the starboard empennage, and from the cockpit through the wing section spanning the two fuselage to the port empennage.

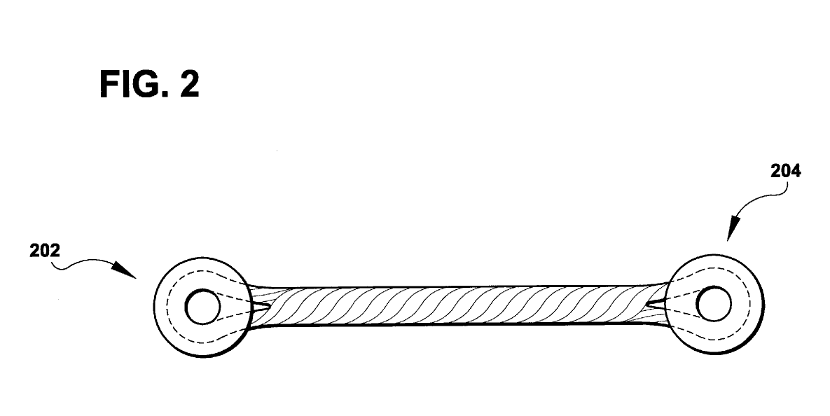

A preferred embodiment of a carbon fiber pull rod manufactured in accordance with the principles of the present invention is shown in FIG. 2. The finished rod in this preferred embodiment comprises 20 complete wraps of carbon tow wound around a pair of aluminum bobbins 202, 204 that are twisted to create the cable, as described in more detail below. In a preferred embodiment, the carbon fiber used to manufacture the cable may be 12K carbon tow, standard modulus (AS4/T300 equivalent) impregnated with a resin such as Magnolia Plastics MB7500 Adhesive.

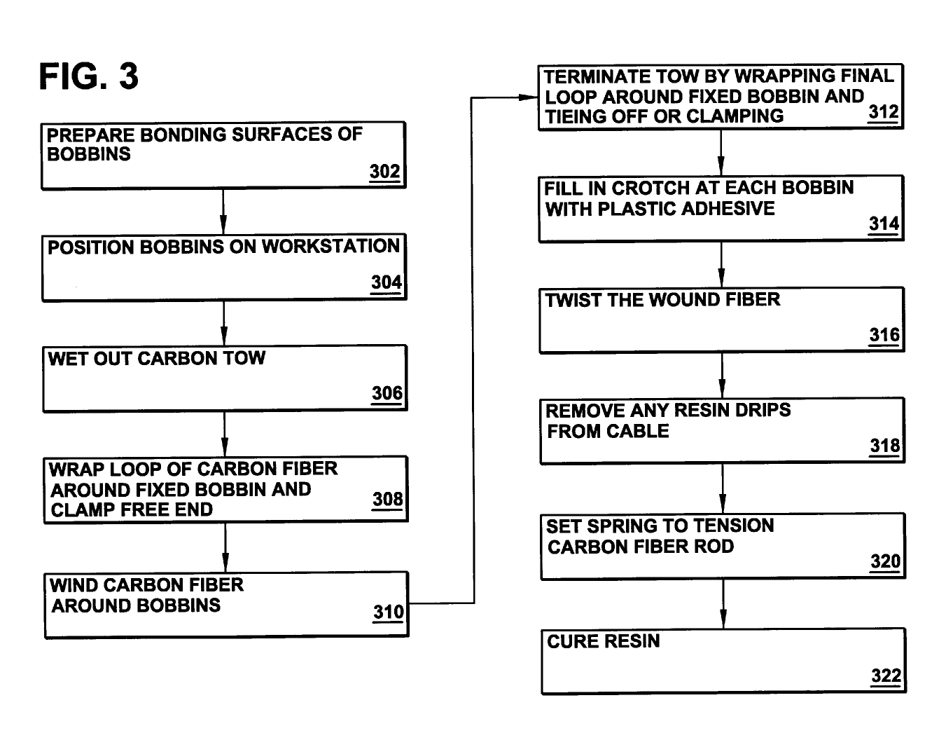

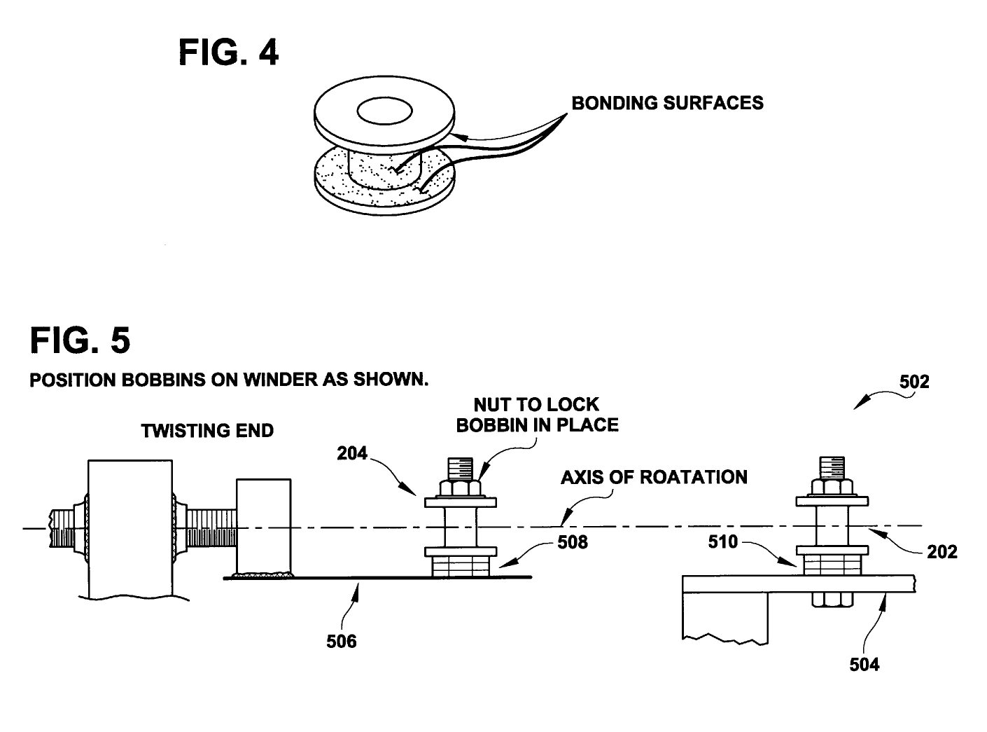

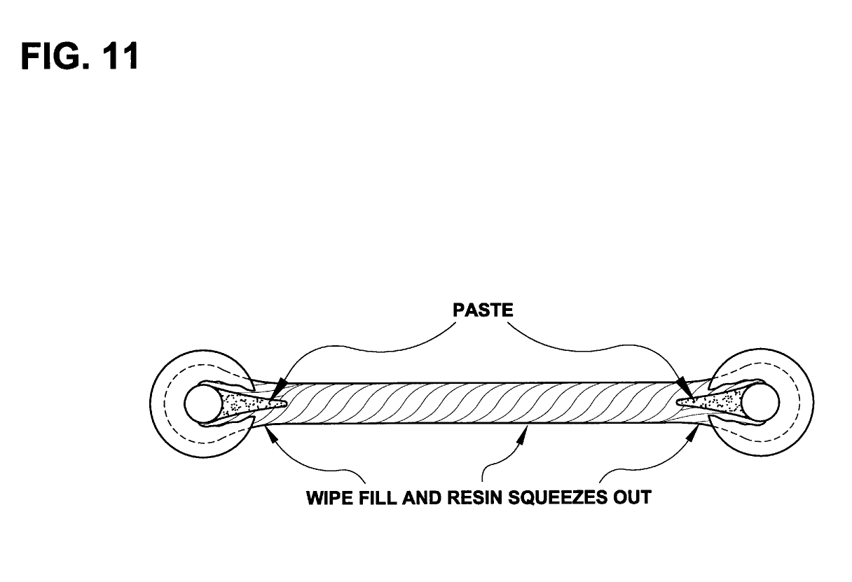

A preferred embodiment of a manufacturing process for fabricating the carbon fiber pull rod shown in FIG. 2 will now be described in connection with FIG. 3 and FIGS. 4-12. As shown in FIG. 3, the first step 302 in the manufacturing process is to prepare the bonding surfaces of the bobbins 202, 204, indicated by arrows in FIG. 4, by for example alodining and applying epoxy or self-etching bonding primer to the bonding surfaces.

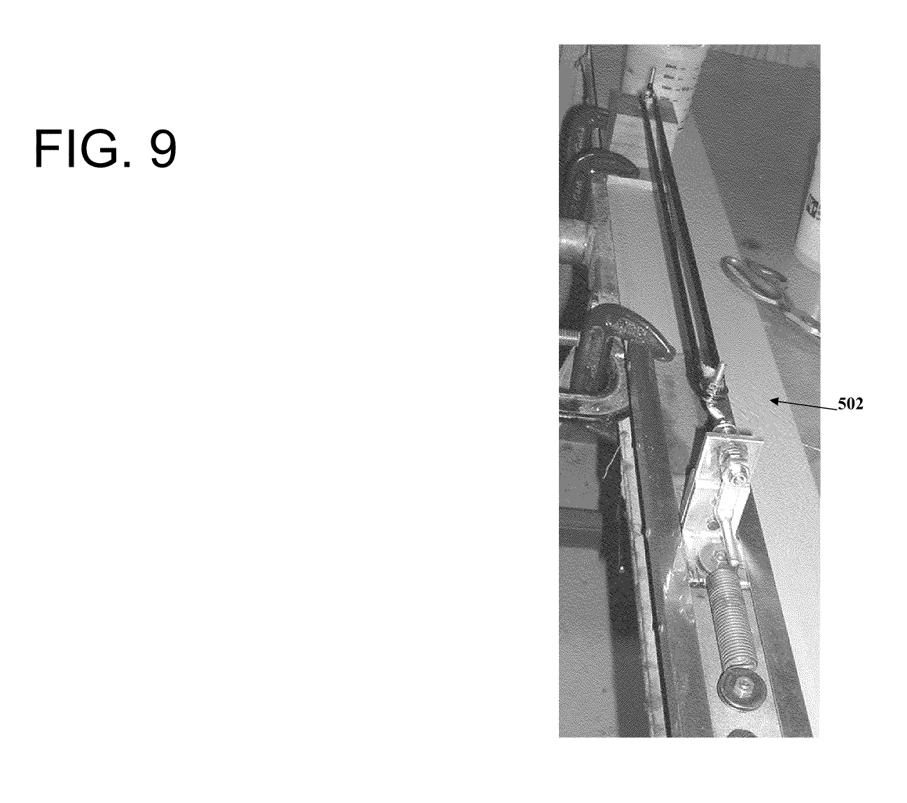

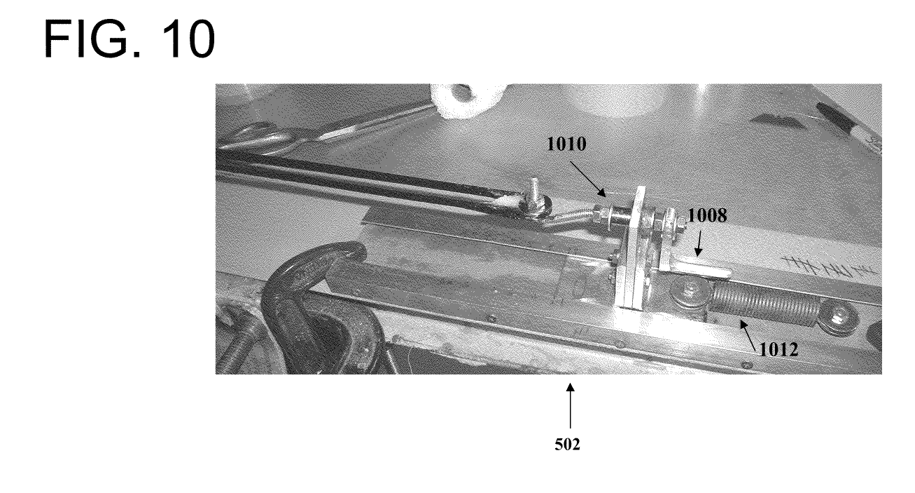

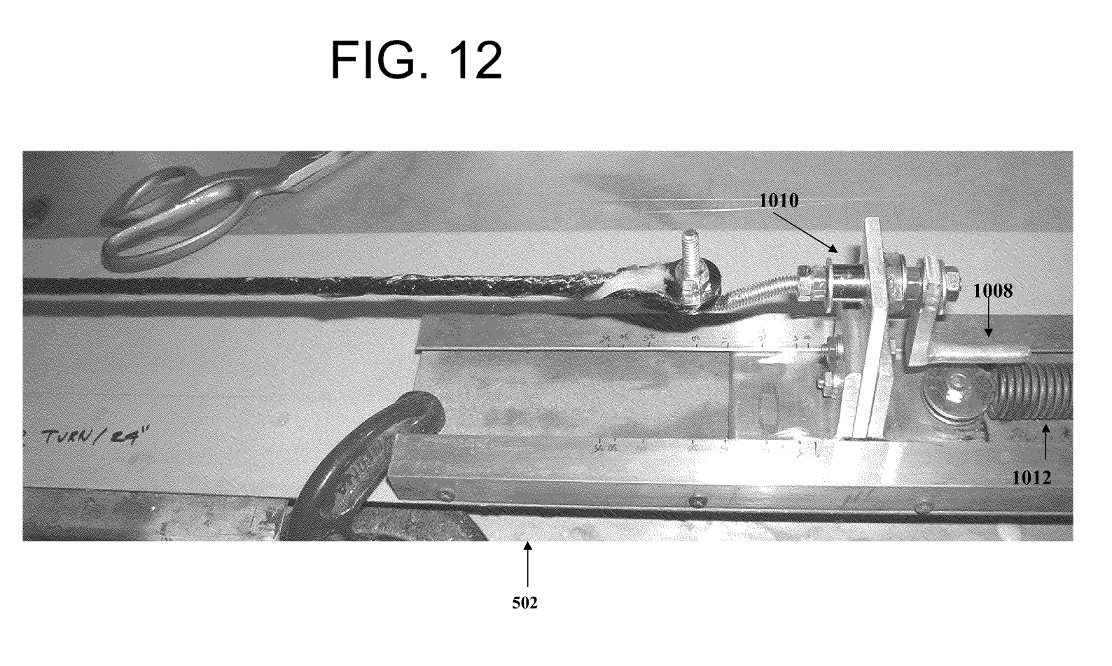

The next step 304 in the process is to position bobbins 202, 204 on a workstation 502 as shown in FIG. 5 and FIG. 9. As shown in those figures, workstation 502 preferably comprises a fixed support 504 to which bobbin 202 is secured by a nut and inverted bolt. Workstation 502 further comprises a twistable support 506 to which bobbin 204 is secured. As best shown in FIG. 10 and FIG. 12, twistable support 506 comprises a handle 1008 secured to a rotatable shaft 1010 oriented parallel to the length of workstation 502. The distal end of shaft 1010 is provided with a means for securing bobbin 204, such as the nut and bent bolt shown in FIG. 10 and FIG. 12. A spring 1012 is provided to permit tensioning of the cable during the manufacturing process, as described below. As illustrated by the dotted line connecting the midpoints of bobbins 202, 204 in FIG. 5, it is important in this preferred embodiment of workstation 502 to ensure that the two bobbins are level with each other in order to provide for a properly formed cable. Spacers 508, 510 may be used as necessary to ensure that the two bobbins are level with each other.

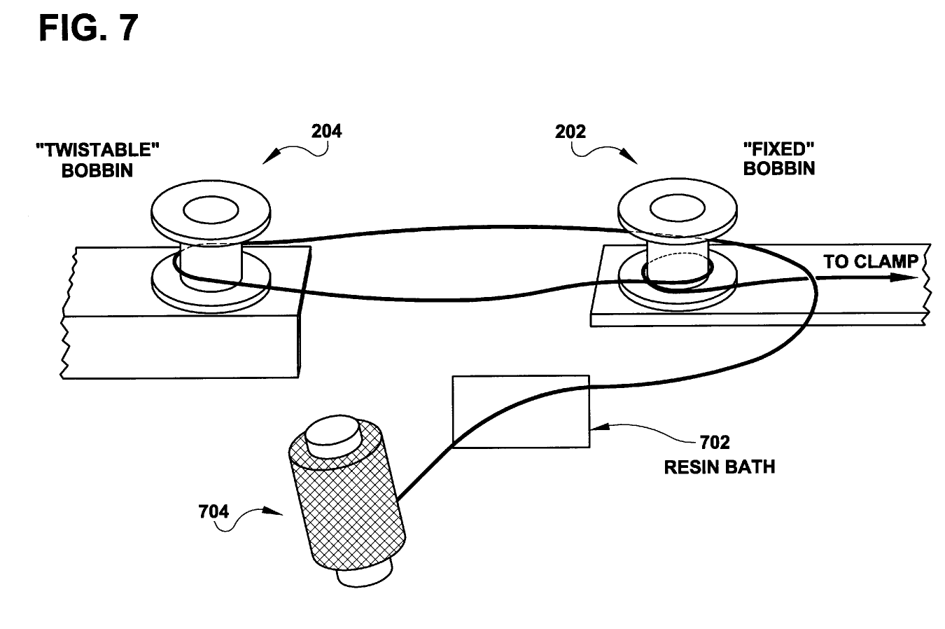

The next step 306 of the process is to wet out the carbon tow prior to winding in accordance with standard aerospace procedures to achieve desired fiber volume. In a preferred embodiment, this desired fiber volume may be approximately 70%. The tow may be wet out by running it through a resin bath 702 placed between a spool of carbon fiber 704 and fixed bobbin 202 as shown in FIG. 7.

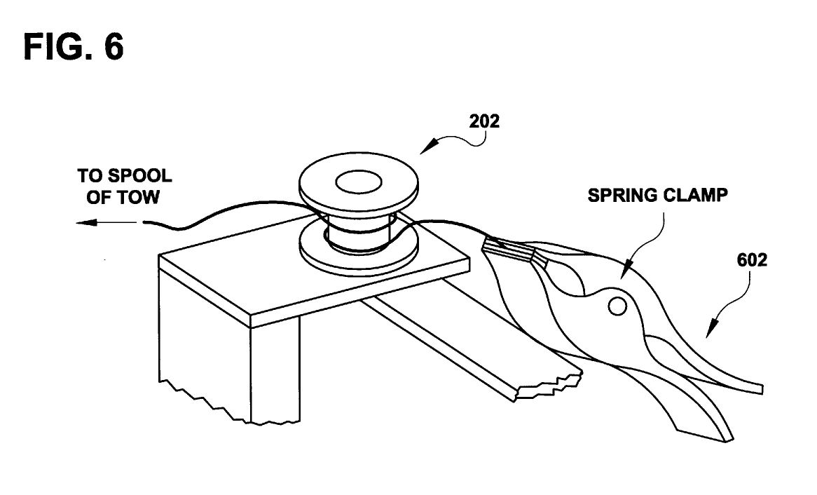

The next step 308 of the process is to wrap one loop of carbon fiber drawn off spool 704 around fixed bobbin 202, and clamp the free end of the carbon fiber with a spring clamp 602 as shown, for example, in FIG. 6, or otherwise secure the free end such as by tieing it off to some part of workstation 502.

The next step 310 of the process is to wind the cable around bobbins 202, 204. In the preferred embodiment illustrated here, 20 complete circuits of wet tow are wound between fixed bobbin 202 and twistable bobbin 204, resulting in a total of 40 strands of tow between the two bobbins.

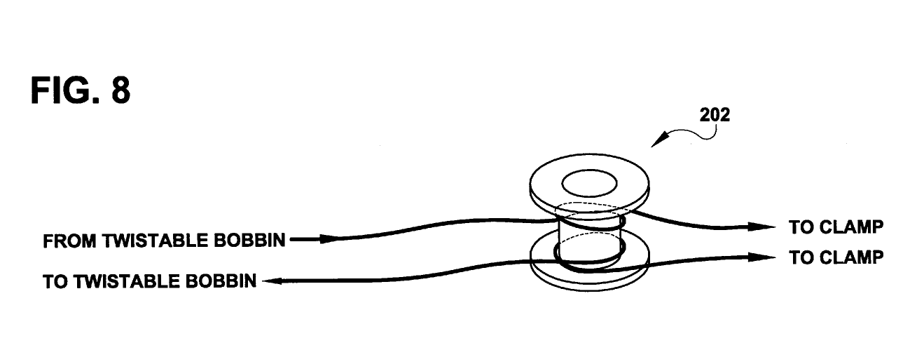

The next step 312 of the process is to terminate the tow by wrapping a final loop around fixed bobbin 202 and clamping the end of the tow or tying it off to some part of workstation 502, as illustrated in FIG. 8.

The next step 314 of the process is to fill the crotch at each bobbin 202, 204 with paste adhesive. In a preferred embodiment, the paste adhesive may be a thixotropic mixture of MB7500 and 4% by weight Wacker Silicones HDK N20 Pyrogenic Silica-Fumed Silica.

The next step 316 of the process is to twist the wound fiber by turning handle 1008. In a preferred embodiment, the cable is twisted six turns per foot of carbon fiber pull rod to be fabricated.

The next step 318 of the process is to wipe away any resin drips from the carbon fiber pull rod. Then, in step 320, spring 412 is set to tension the carbon fiber pull rod with 50 pounds to ensure proper squeeze out of the resin and to remove sag as the carbon tow settles in. Finally, in step 322, the resin is cured in accordance with the manufacturer's instructions. Cables of any desired length may be constructed using the manufacturing process described above by positioning bobbins 202, 204 at an appropriate distance from each other.

In a preferred embodiment, the control system of the aircraft shown in FIG. 1 is implemented using carbon fiber pull rods of approximately 0.20 inches diameter exhibiting a test break strength of approximately 6000 pounds (RT-dry) manufactured in accordance with the process described above.

It should be recognized that although the carbon fiber pull rods of the present invention exhibit superior characteristics to traditional steel with respect to use in aircraft control cables, the carbon fiber pull rods of the present invention are not sufficiently flexible to permit them to be used around pulleys or sectors. Accordingly, in a preferred embodiment of the present invention, an aircraft control cable may be constructed of two or more segments, wherein one or more of the segments are carbon fiber and one or more of the segments are stainless steel. In particular, for lengths of the cable where no change of direction is required, the cable is preferably constructed from carbon fiber pull rods, while conventional stainless steel cable is used for portions of the control cable that pass around pulleys and sectors. In a preferred embodiment, a cable primarily constructed of carbon fiber may also be provided with one or more steel segments where it is desired to provide the cable with stretching capacity to allow for changes in cable length during operation of the aircraft. For example, where the desired length of a control cable to be run along the length of a wing may be expected to change as a result of changes in curvature of the wing during flight, a steel segment in an otherwise carbon fiber cable may be used to provide adequate stretching capacity to avoid undesirable stress on the cable. Preferably, the system is preloaded to 150 pounds tension on all cables.

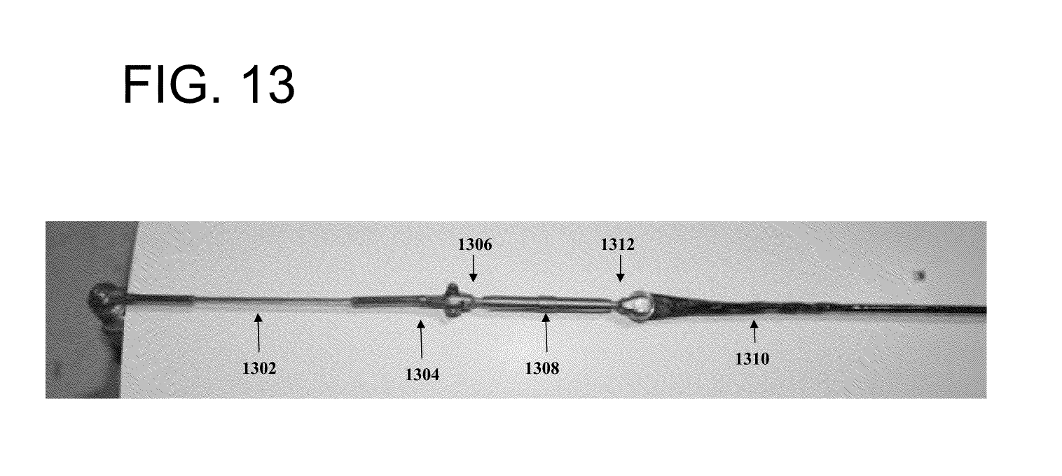

The transition or interface between the carbon composite pull rods and steel cable may be achieved, for example, using standard connecting hardware such as a fork or clevis. As shown, for example, in FIG. 13, a standard steel cable 1302 terminating with a spade 1304 may be connected via a fork 1306, turnbuckle 1308, and second fork 1312 to a carbon fiber pull rod 1310.

In a preferred embodiment, the stainless steel cable used to go around pulleys or sectors may be 5/32 stainless steel cable (7×19) having a breaking strength of 2400 pounds. Additionally, all sectors, bell cranks, and similar actuating structures in the control force path are preferably mounted on ball bearings for low friction and high reliability.

In a preferred embodiment, additional protection of carbon fiber pull rods against abrasion or other damage, including heat or water damage, in highly susceptible areas is provided. This may be an important aspect of the use of carbon fiber pull rods of the present invention because, although these carbon fiber pull rods exhibit superior performance characteristics to those of steel in control system applications, they may also be more susceptible to abrasion or other damage than steel rods if not properly protected.

In addition to meeting the requirements of FAR Parts 23 and 25, the control system of the present disclosure is preferably designed with the following factors of safety in order to balance robustness under load with the need for low weight. When subjected to maximum FAR permissible pilot effort, i.e., dual pilot control, push rods in buckling and carbon fiber pull rods in tension preferably exhibit a 3.0 safety factor. General stresses are preferably designed to a safety factor between 1.5 and 2.0. Bearing stresses are designed to a 2.0 safety factor. Tension loads on steel cable are designed to a 1.5 safety factor based upon the minimum rated break strength.

The present disclosure presents many advantages over a conventional steel cable control system. In addition to those already mentioned, in an aircraft such as the White Knight 2, which is designed and constructed of a composite material in the fuselage and internal structure, composite control cables will exhibit similar thermal expansion patterns, therefore reducing stress on the control cables due to any thermal expansion, which itself is reduced as compared to conventional steel cables. The carbon fiber pull rod cables of the present disclosure exhibit a higher stiffness than equivalent metal cables of the same weight. The potential for weight saving is particularly important in the presently contemplated application of aircraft or spacecraft.

Although the present disclosure has been described in relation to particular embodiments thereof, many other variations and modifications and other uses will become apparent to those skilled in the art. Accordingly, the scope of the present invention should be limited not by the specific disclosure herein, but only by the appended claims.

1. A process for making a carbon fiber pull rod, comprising:
a. wetting carbon fiber tow with a resin;
b. winding the carbon fiber tow around first and second spaced bobbins, wherein the number of windings around the first and second spaced bobbins is approximately 20;
c. twisting the wound carbon fiber tow around an axis parallel to the intended length of the carbon fiber pull rod, wherein the wound carbon fiber tow is twisted approximately six times per foot of carbon fiber pull rod being made; and
d. curing the resin.

2. A control cable for use in an aircraft control system, the control cable comprising:
a first segment comprising a first carbon fiber pull rod;
a second segment comprising steel cable, said second segment being adapted to pass around a pulley or sector; and
a connector for connecting said carbon fiber pull rod to a first end of said steel cable.

3. The control cable of claim 2, further comprising:
a third segment comprising a second carbon fiber pull rod; and
a second connector for connecting said second carbon fiber pull rod to a second end of said steel cable.

4. An aircraft, comprising:
at least one fuselage, said fuselage comprising a cockpit;
at least one empennage;
a control system, the control system comprising at least one control cable running from the cockpit to the empennage;
the control cable comprising a carbon fiber pull rod.

5. The aircraft of claim 2, wherein the carbon fiber pull rod is shielded from heat damage.

6. The aircraft of claim 2, wherein the carbon fiber pull rod is shielded from water damage.

7. The aircraft of claim 1, wherein the carbon fiber pull rod is shielded from abrasion.
